(19) United States
(12) Patent Application Publication
(10) Pub. No.: US 2006/0020760 A1
(43) Pub. Date: Jan. 26, 2006

(54) Method, system, and program for storing sensor data in autonomic systems

(75) Inventors: Mokhtar Kandil, Toronto (CA); Volker Gerhard Markl, San Jose, CA (US)

Correspondence Address: SUGHRUE MION PLLC;USPTO CUSTOMER NO WITH IBM/SVL, 2100 PENNSYLVANIA AVENUE, N.W., WASHINGTON, DC, 20037, US

(73) Assignee: International Business Machines Corporation, Armonk, NY (US)

(21) Appl. No.: 10/898,466

(22) Filed: Jul. 22, 2004

(51) Int. Cl. G06F 12/00

(52) U.S. Cl. 711/154

(57) ABSTRACT

An autonomic system directed to opportunistically store captured data from at least two writer processes executing in an autonomic system. The method includes: creating a pool of storage locations in which data can be stored by the at least two writing processes, one of the at least two writer processes capturing data to be stored; selecting a storage location from the pool for the one of said at least two writer processes; and determining if the selected file is available for writing by the one of the at least two writer processes and writing the captured data to the storage location if it is available.

### FIELD OF THE INVENTION

The present invention relates to storing computer information. More specifically, the present invention relates to a method, a system and a computer program product for storing sensor data in an autonomic system.

### BACKGROUND OF THE INVENTION

Many systems create and store information describing their operation and/or errors they experience. A common example of such information is the log files created by many software systems, such as database systems. These log files consist of entries relating to events or states of the system and are typically used to diagnose failures and/or unpredicted operating conditions. Typically, system administrators, or other individuals, must manage these log files, which can grow too large over time as entries continue to accumulate and/or which require culling to remove old entries which are no longer of interest, etc.

In addition to the problems mentioned above, in distributed systems and/or multiprocessor systems, additional difficulties can occur as two processes can need to write to the same log file at the same time, resulting in contention which causes one process to pause in its execution while awaiting the log file to be freed for writing by the other process and this negatively impacts the overall performance of the system.

Recently, research and development has commenced in the field of autonomic computing systems. An overview of autonomic computing is given in, “The Vision of Autonomic Computing”, Jeffery O. Kephart and David M. Chess, Computer, January 2003, pp 41-50. An autonomic computing system is one which monitors itself and adjusts its operation to the conditions it experiences to improve its performance for current operating conditions and to recover from errors it has experienced. An autonomic system can configure itself one way when it is operating under one set of conditions, for example being lightly loaded, and can configure itself another way when it is operating under another set of conditions, for example being heavily loaded. Autonomic systems are intended to operate largely without human supervision or, in other words, an autonomic system is one which is intended to manage itself.

Autonomic systems must therefore “know themselves” and are typically described as having “sensors” which record information of interest to the system about the operation of the system. These sensors produce data which is used by various autonomic processes in the system to manage operation of the system. For example, a sensor can measure the percentage of buffer space which is used by the system and an autonomic process can use that information to increase or decrease the amount of buffer space according to changes in the load on and/or applications run on the system over time.

One of the difficulties with autonomic systems is the storage of sensor data. Specifically, conventional log files and other file structures for sensor data suffer from a variety of disadvantages. For example, the above-mentioned contention problems can be exacerbated in autonomic systems as multiple sensors are typically employed in such systems and contention will often occur as two or more sensors attempt to write sensor data to the same storage location. Further, large amounts of sensor data can be captured and, left unmanaged, storage of this sensor data could require a disproportionate amount of the storage space of the system.

### SUMMARY OF THE INVENTION

It is an object of the present invention to provide a novel system and method for storing sensor data in autonomic systems which obviates or mitigates at least one disadvantage of the prior art.

According to a first aspect of the present invention, there is provided, for an autonomic system, a method of directing the autonomic system to opportunistically store captured data from at least two writer processes executing in an autonomic system, the method including the steps of creating a pool of storage locations in which data can be stored by the at least two writing processes, one of the at least two writer processes capturing data to be stored, selecting a storage location from the pool for the one of said at least two writer processes, and determining if the selected file is available for writing by the one of the at least two writer processes and writing the captured data to the storage location if it is available.

According to another aspect of the present invention, there is provided, for an autonomic system, a computer program product for directing the autonomic system to opportunistically store captured data from at least two writer processes executing in an autonomic system, the computer program product including a computer readable medium tangibly embodying computer executable code for directing the autonomic system, the computer executable code including code for creating a pool of storage locations in which data can be stored by the at least two writing processes, one of the at least two writer processes capturing data to be stored, code for selecting a storage location from the pool for the one of said at least two writer processes, and code for determining if the selected file is available for writing by the one of the at least two writer processes and writing the captured data to the storage location if it is available.

### BRIEF DESCRIPTION OF THE DRAWINGS

Preferred embodiments of the present invention will now be described, by way of example only, with reference to the attached Figures, wherein:

FIG. 1 shows a schematic representation of an autonomic system;

FIG. 2 shows a schematic representation of data storage system in accordance with the present invention; and

FIG. 3 shows a flowchart of a method of storing data in accordance with the present invention.

### DETAILED DESCRIPTION OF THE INVENTION

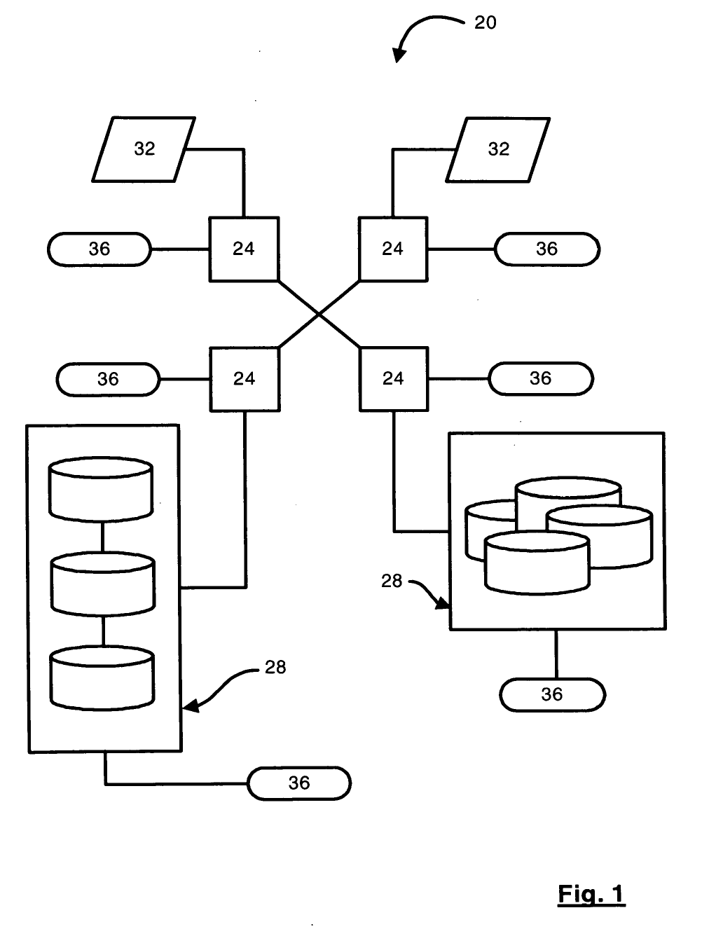

An autonomic system is indicated generally at 20 in FIG. 1. An autonomic system such as system 20 can include one or multiple processors 24, one or multiple storage devices 28 and one or multiple input and/or output devices 32. The actual construction and arrangement of system 20 is not particularly limited and if multiple processors 24 are included, processors 24 can be distributed processor systems or a single system multi-processor assembly, etc. Similarly, storage devices 28 can be one or more disk drives, solid state memory devices, tape libraries, etc. and input and/or output devices 32 can be keyboards, monitors, touch screens, printers, etc. Autonomic system 20 can be a single user system, but it is contemplated that more commonly system 20 will be a multi-user, or at least a multi-process, system.

Autonomic system 20 further includes a variety of sensors 36 which monitor and measure various aspects of the operation of system 20. As used herein, the term “sensor” is intended to comprise any device, mechanism or process for monitoring a desired operating characteristic of system 20, essentially a sensor 36 can be any writer process in system 20 concerned with the storage of operating data of system 20. Accordingly, a sensor 36 can comprise a hardware device, such as a thermister to monitor the operating temperature of a component of system 20 for example, but it is contemplated that, more commonly, a sensor 36 will comprise a software process which is executed within system 20 to instrument one or more aspects of the operation of system 20. For example, sensors 36 can be employed to instrument the load on a processor 24, the free space on a storage device 28, the number of users logged into system 20, the amount of memory or other system resources being used by a process, etc.

Sensors 36 are intended to monitor and measure parameters which will be of use in the autonomic management and operation of system 20 and the data captured by sensors 36 is stored in one or more of storage devices 28 of system 20. While a specific storage device 28 can be provided specifically for the storage of sensor data, it is contemplated that more commonly sensor data will be stored on available storage devices 28 which are used generally by system 20 for storing data.

An important principle of autonomic computing is that the capture of sensor data is performed opportunistically. Specifically, sensor data is captured and stored when this can be performed without unduly impacting the performance of system 20. Thus, when system 20 is moderately loaded, data from sensors 36 will be captured and stored but when system 20 is heavily loaded, some data from at least some sensors 36 can be discarded, if necessary, so as not to negatively impact the performance of system 20 by consuming processor cycles or other system resources which are required to serve user or system processes. However, it is desired to have at least some of the data from sensors 36 even when system 20 is heavily loaded so that this data can be analyzed by autonomic processes executing on system 20 to determine what, if anything, system 20 can do to alleviate its highly loaded state or to more effectively operate in that state.

The present invention provides a system and method which allows storage and management of sensor data in an automatic, self-maintaining and opportunistic manner. The system and method includes a pool of storage locations to which autonomic sensor data can be written to and read from. While in the embodiment of the invention discussed below, the storage locations are files maintained in a file system, the present invention is not so limited and any suitable storage location can be employed. Examples of other suitable storage locations can include, without limitation, tables in database management systems, portions of the autonomic system main memory, etc.

A sensor 36 that needs to write data can request a file from the pool, the file being selected by an appropriate selection technique, such as round robin, random selection, a hash-based selection or any other suitable technique. Once a file is selected from the pool of files, a determination is made as to whether the selected file is currently locked for writing by another sensor 36 or is locked for reading by an autonomic control process. If the selected file is locked, a retry is performed wherein another file is selected and checked to determine if it is presently locked. After a predefined number of retries, the sensor 36 abandons the attempt to store its sensor data and the data is discarded, the assumption here being that the system is heavily loaded and no more resources should be consumed attempting to store the sensor data.

Assuming one of the file selections is successful and the sensor 36 is provided with a file that it can write to, the sensor data is written to that file along with the necessary data to identify the sensor 36 that wrote it and any other data which will be required by the autonomic process using that data, such as the time the data was captured, etc.

In a present embodiment of the invention, a maximum size is predefined for each file in the pool and multiple sensors 36 can store their data in a file provided that the maximum size is not exceeded. Once the maximum size of a file is exceeded, a purge of the file contents is performed. In the case of storage locations other than files, a similar size determination can be performed. For example, if the storage locations being employed are buffers of pre-defined size in the main memory of system 20, then a determination is made as to how much of that predefined buffer size is in use. Similar determinations can be made for other types of storage locations.

It is currently contemplated that one of two purge strategies will be employed, the first strategy being a delete and the second being a circular re-write. For the delete strategy, the entire contents of the file are deleted and the new data is written to the now empty file. The advantages of this strategy are its speed and the low amount of system resources required to perform the delete while the disadvantages of this strategy are that all of the data in the file is deleted and will no longer be available to autonomic processes running on system 20. A further sub-division of the delete strategy can also be made with respect to setting the maximum size of a file. Specifically, in one sub-strategy the maximum size of a file can be set as a “hard” limit, wherein if the file is one hundred bytes less than it's maximum size and one hundred and twenty bytes need to be written, the file is deemed to be full and is purged before writing the new data. In the second sub-strategy, new data can be written to the file until the “soft” maximum size of the file is first exceeded. In the example above, the one hundred and twenty bytes of new data would be written to the file and the next write attempt after the “soft” maximum file size has been exceeded would result in a purge of the file. This second sub-strategy is presently preferred as system 20 need not track the size of the data to be written and is believed to provide best performance when the maximum file size is selected to be an order of magnitude or more greater in size than the expected amount of data the average sensor 36 will need to record.

The circular re-write strategy acts much like a circular buffer wherein the file has a hard maximum size and new data written to the file will overwrite the oldest data in the file. The advantages of this strategy are that potentially less data is purged before being used by the system and, as it is expected that such purging will most often be required when the system is heavily loaded, the data useful for analyzing the heavily loaded state will overwrite older data which is likely of less interest. The disadvantages of the circular purge strategy are that it requires more time and resources to perform.

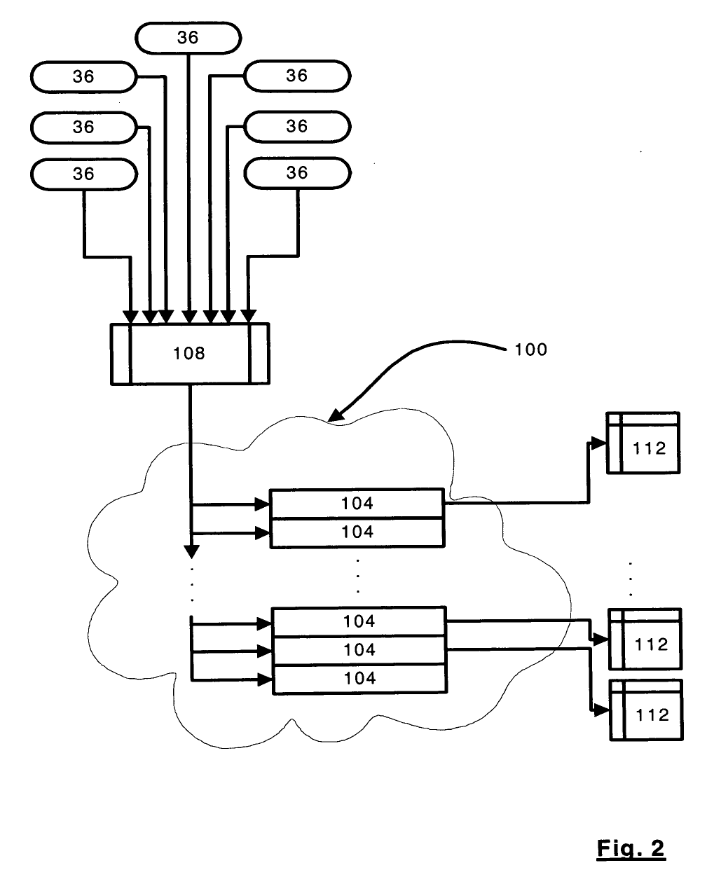

A data storage system in accordance with the present invention is shown schematically in FIG. 2. As shown, the present invention provides a pool 100 of data files 104 to which sensor data can be written to and read from. A storage controller 108, which is typically a process running on system 20 or at each sensor 36, but which can also be a separate hardware device such as another processor, manages the assignment of one of these data files 104 to a sensor 36 that is requesting to store data. Autonomic or other processes 112 can read data from the files 104, as needed.

A sensor 36 writing to a file 104 will lock that file so that it has exclusive write access to the file but often will not lock the file to prevent an autonomic process 112 from beginning simultaneous reading from the file after the write has started. Typically, autonomic processes 112 read from files 104 at a slower rate than sensors 36 write data to such files and thus a process 112 can read from the file before a sensor 36 has completed writing to that file. However, while autonomic process 112 is reading from a file, it will lock sensors 36 other than the first sensor 36 from accessing that file to purge and/or overwrite data in that file 104.

It is contemplated that the number of files 104 in pool 100 can be selected in a variety of manners. For example, it may be desired to provide a constant number of files 104 in pool 100. Conversely, the number of files in pool 100 can be varied with the load and/or available resources in system 20. In this latter case, for example, forty files can be provided in pool 100 until the load on system 20 exceeds a pre-defined level, after which the number of files 104 in pool 100 can be reduced to thirty to free resources for use by system 20.

It is also contemplated that pool 100 can be arranged into one or more sub-pools where, for example, a sub-pool can be designated for use by a set, or class, of sensors 36 which are the only sensors 36 that can write to files in that sub-pool. In this manner, sensor data can be prioritized by assigning important sensors 36 to a sub-pool with a large number of files 104, relative to the number of sensors 36 assigned to the sub-pool and/or the data storage requirements of those sensors 36, and the other sensors 36 in system 20 being assigned to another sub-pool with relatively fewer files 104. Similarly, the use of sub-pools can provide fairness or other sharing characteristics as desired. Also, it is contemplated that each sensor 36 or group of sensors 36 can have their own sub-pool defined for it, these sub-pools being able to having overlapping members (i.e.—one or more files 104 being members in more than one sub-pool) and/or one or more files 104 which are uniquely assigned to a particular sub-pool.

Many other strategies and techniques for managing the number of files 104 in pool 100 can be employed without departing from the present invention, as will be apparent to those of skill in the art.

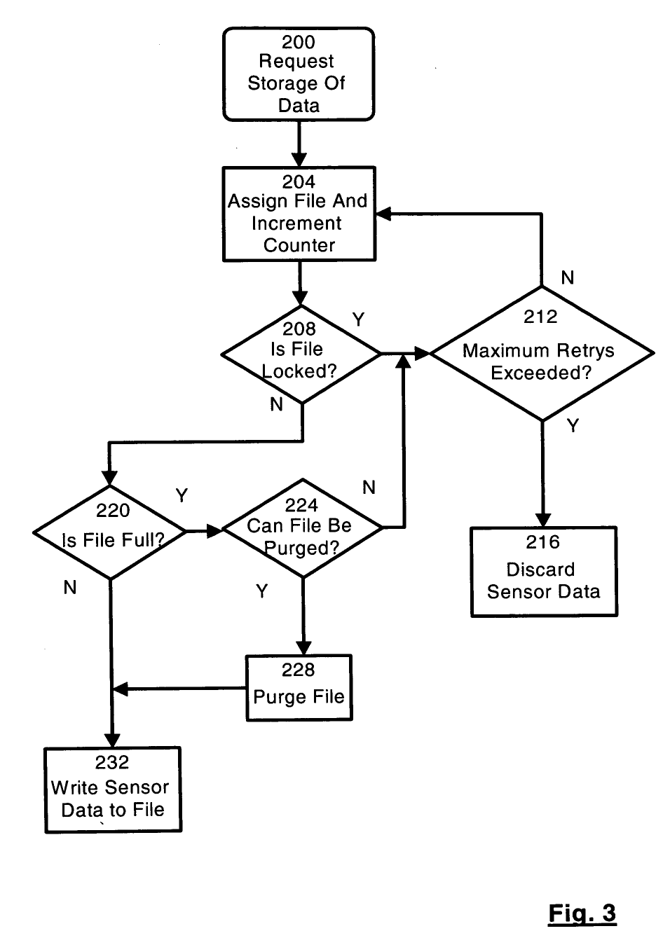

FIG. 3 shows a flowchart of a method of managing storage of data in accordance with the present invention. The method commences at step 200, where a sensor 36 requests storage controller 108 to assign a file 104 to requesting sensor 36 to store data in. At step 204, storage controller 108 selects a file 104 from pool 100 for requesting sensor 36 and initializes a retry counter for requesting sensor 36.

The actual method by which storage controller 108 selects a file 104 for a requesting sensor 36 is not particularly limited and can include a random selection, a round robin selection, a hash-based selection or any other selection that may be desired and which would occur to those of skill in the art. It is contemplated that a wide variety of suitable selection functions can be employed without departing from the scope of the invention.

Further, as mentioned above, pool 100 can be divided into one or more sub-pools from which files are selected for various requesting sensors 36. For example, if pool 100 contains fifty files 104, pool 100 can be arranged into two sub-pools, each of which contains twenty-five files 104. Assuming one or more particular sensors 36p should have a priority assigned to the collection of their data, for example a sensor 36p which is related to security of system 20, then storage controller 108 will only assign the files in one sub-pool to those sensors 36p and will assign files from the other sub-pool to all other sensors 36 in system 20. In this manner, the probability that a prioritized sensor 36p will be unable to store its sensor data is reduced. Alternatively, all files in pool 100 can be available to all sensors 36, but the maximum number of retries for prioritized sensors 36p can be higher than that for other sensors 36 to increase the likelihood that data from a prioritized sensor 36p will be stored.

At step 208, once the requesting sensor 36 has had a file 104 assigned to it, a determination is made as to whether the assigned file is locked against writing by requesting sensor 36. Such a lock can occur because the file 104 has previously been assigned to another sensor 36 which has locked the file and has not yet completed writing to it and released its lock, or because an autonomic process 112 has locked the file against further writing while process 112 reads the file contents.

If the assigned file 104 is locked, a check is performed at step 212 of the count of the retry counter for the requesting sensor 36. If the count on the retry counter indicates that a pre-defined maximum number of retries has been performed, then the data from the requesting sensor 36 is discarded at step 216 and the process terminates for the request made by that that sensor 36. When the requesting sensor 36 next has data to be stored, it will recommence the process at step 200.

However, if at step 212 the maximum number of retries has not been exceeded, the method returns to step 204 and storage controller 108 increments the retry counter for requesting sensor 36 and selects another file 104.

If at step 208 the selected file 104 is not locked, then an appropriate check is performed at step 220 as to whether the selected file 104 is full. This determination is effected according to the selected delete strategy and/or sub-strategy as discussed above. Specifically, if a circular rewrite purge strategy has been adopted, a determination will be made to see if the “hard” maximum size has been reached. If a delete purge strategy has been adopted and the sub-strategy is the “hard” limit strategy, a determination is made as to whether that maximum size that will be exceeded by the writing of the data of the sensor 36 of id the sub-strategy is the “soft” limit strategy, a determination is made if the “soft” maximum file size was exceeded by the last write to the file.

If the file is determined to be full at step 220, then a determination is made at step 224 as to whether the file can be purged. Various criteria can be employed to determine when a file can be purged to insure that a reasonable chance exists that desirable sensor data will be available to system 20. For example, criteria can be employed which will not allow purging of a file 104 by a sensor 36 unless that sensor is within one count of its maximum number of retries, as indicated by its retry counter. In this way, files 104 are unlikely to be purged from system 20 when other files 104 are available for writing. It is contemplated that other criteria and/or purge strategies can be employed, as will occur to those of skill in the art, without departing from the scope of the present invention.

If at step 224 it is determined that the assigned file 104 cannot be purged, the process proceeds to step 212 and then to either step 204 or step 216 as appropriate.

Conversely, if at step 224 it is determined that the file can be purged, then at step 228 file 104 is purged using the purge technique employed in system 20, for example, either a delete of the contents of file 104 at step 228 and a write of the data of the requesting sensor 36 at step 232 or a circular re-write of the new data within file 104 at step 232.

Thus, when system 20 is lightly loaded and/or sufficient files are available in pool 100, each sensor 36 requiring a file 104 to store its data is assigned a free (not locked) data file 104 by storage controller 108, thus contention between sensors 36 writing data and/or autonomic processes 112 reading that data is prevented. When system 20 is heavily loaded, or under any other circumstance wherein all of data files 104 in pool 100 are in use and no or few unlocked files 104 are present, file manager 108 will retry a fixed number of times to obtain a file 104 for a sensor 36 with data to be stored and, after the maximum number of retries has been met, the sensor 36 will discard its data in accordance with the opportunistic manner in which sensor data is captured in system 20.

System 20 can include an autonomic process 112 which will determine and monitor the average number of retries the sensors 36 in system 20 must make before they can write their sensor data to a file 104. Depending upon this average, this autonomic process 112 can increase or decrease the number of files 104 in pool 100 to dynamically adapt this aspect of system 20 to its experienced workload.

The present invention has been tested in the LEO system which is an autonomic query optimizer for the DB2 database system of the assignee of the present invention. In the test LEO system, the maximum number of retries allowed has been set to two and purging of files 104 can be performed after a first retry. Further, in this implementation, files 104 are selected from pool 100 for sensors 36 in a pseudo-random manner.

The present invention provides a system and method for storing data, such as sensor data, in an automated system, such as an autonomic system or the like. The system and method are scalable and self-maintaining and allow for opportunistic monitoring of sensor data in an autonomic system or the like. Contention between concurrent processes is reduced as is the overhead imposed by the system and method on the autonomic system.

While the description above has principally concerned the use of files as storage locations, the present invention is not so limited and other types of storage locations can be employed, such as buffers in main memory, tables and other structures in database management systems, etc. It is further contemplated that pool 100 can comprise more than one type of storage location, for example having some storage locations in main memory and some in files in a file system.

The above-described embodiments of the invention are intended to be examples of the present invention and alterations and modifications may be effected thereto, by those of skill in the art, without departing from the scope of the invention which is defined solely by the claims appended hereto.

We claim:

1. For an autonomic system, a method of directing the autonomic system to opportunistically store captured data from at least two writer processes executing in an autonomic system, comprising the steps of:
creating a pool of storage locations in which data can be stored by the at least two writing processes, one of the at least two writer processes capturing data to be stored;
selecting a storage location from the pool for the one of said at least two writer processes; and
determining if the selected file is available for writing by the one of the at least two writer processes and writing the captured data to the storage location if it is available.

2. The method of claim 1 further comprising:
repeatedly performing the steps of selecting and determining until the selected storage location is available and the captured data has been written to the selected storage location if the selected storage location is not available for writing.

3. The method of claim 1 further comprising:
repeatedly performing the steps of selecting and determining until a pre-defined number of attempts is made to select the storage location and the data to be written is discarded without writing the data, if the selected storage location is not available for writing.

4. The method of claim 1 wherein the determination of whether the selected storage location is available for writing comprises determining if the storage location is locked against writing by another process executing on said self-managing system.

5. The method of claim 4 wherein the determination of whether the selected storage location is available for writing further comprises the step of, if the storage location is not locked against writing, determining if the size of the storage location exceeds a pre-defined maximum size, the storage location being available for writing if it does not exceed the pre-defined maximum size.

6. The method of claim 4 wherein the determination of whether the selected storage location is available for writing further comprises the step of, if the storage location is not locked against writing, determining if the size of the storage location plus the amount of data to be written will exceed a pre-defined maximum size, the storage location being available for writing if the pre-defined maximum size would not be exceeded by the writing of the captured data.

7. The method of claim 1 wherein the step of selecting is performed using one of:
a pseudo-random selection technique;
a round-robin selection technique; and
a hash-based selection technique.

8. The method of claim 3 where, if the size of the storage location exceeds the pre-defined maximum size, determining if the contents of the storage location can be purged and, if the contents can be purged, purging the contents of the storage location and writing the captured data to the file.

9. The method of claim 8 wherein the determination of whether the selected storage location can be purged is made according to whether more than a pre-defined number of attempts has been made to select a storage location for the one of the at least two writer processes.

10. The method of claim 4 where, if the size of the storage location plus the amount of data to be written exceeds a pre-defined maximum size, determining if the contents of the storage location can be purged and, if the contents can be purged, purging the contents of the storage location and writing the captured data to the storage location.

11. The method of claim 10 wherein the determination of whether the selected storage location can be purged is made according to whether more than a pre-defined number of attempts has been made to select a storage location for the one of the at least two writer processes.

12. For an autonomic system, a computer program product for directing the autonomic system to opportunistically store captured data from at least two writer processes executing in an autonomic system, the computer program product comprising:
a computer readable medium tangibly embodying computer executable code for directing the autonomic system, the computer executable code comprising:
code for creating a pool of storage locations in which data can be stored by the at least two writing processes, one of the at least two writer processes capturing data to be stored;
code for selecting a storage location from the pool for the one of said at least two writer processes; and
code for determining if the selected file is available for writing by the one of the at least two writer processes and writing the captured data to the storage location if it is available.

13. The computer program product of claim 12 further comprising:
code for repeatedly executing the code for selecting and the code for code for determining until the selected storage location is available and the captured data has been written to the selected storage location if the selected storage location is not available for writing.

14. The computer program product of claim 12 further comprising:
code for repeatedly executing the code for selecting and the code for code for determining until a pre-defined number of attempts is made to select the storage location and the data to be written is discarded without writing the data, if the selected storage location is not available for writing.

15. The computer program product of claim 12 wherein the determination of whether the selected storage location is available for writing comprises determining if the storage location is locked against writing by another process executing on said self-managing system.

16. The computer program product of claim 15 wherein the determination of whether the selected storage location is available for writing further comprises the step of, if the storage location is not locked against writing, determining if the size of the storage location exceeds a pre-defined maximum size, the storage location being available for writing if it does not exceed the pre-defined maximum size.

17. The computer program product of claim 15 wherein the determination of whether the selected storage location is available for writing further comprises the step of, if the storage location is not locked against writing, determining if the size of the storage location plus the amount of data to be written will exceed a pre-defined maximum size, the storage location being available for writing if the pre-defined maximum size would not be exceeded by the writing of the captured data.

18. The computer program product of claim 12 wherein the code for selecting uses one of:
a pseudo-random selection technique;
a round-robin selection technique; and
a hash-based selection technique.

19. The computer program product of claim 14 further comprises:
code for determining if the contents of the storage location can be purged if the size of the storage location exceeds the pre-defined maximum size; and
code for purging the contents of the storage location and writing the captured data to the file if the contents can be purged.

20. The computer program product of claim 19 wherein the determination of whether the selected storage location can be purged is made according to whether more than a pre-defined number of attempts has been made to select a storage location for the one of the at least two writer processes.

21. The computer program product of claim 15 further comprising:
code for determining if the contents of the storage location can be purged if the size of the storage location plus the amount of data to be written exceeds a pre-defined maximum size; and
code for purging the contents of the storage location and writing the captured data to the storage location if the contents can be purged.

22. The computer program product of claim 21 wherein the determination of whether the selected storage location can be purged is made according to whether more than a pre-defined number of attempts has been made to select a storage location for the one of the at least two writer processes.
